(19) United States
(12) Patent Application Publication
(10) Pub. No.: US 2025/0050182 A1
(43) Pub. Date: Feb. 13, 2025

(54) METHOD FOR PROVIDING SPORTS TRAINING VIDEOS USING A CAMERA AND A RADAR SENSOR

(71) Applicant: Soo-Youn KANG, Seoul (KR)

(72) Inventors: Soo-Youn KANG, Seoul (KR); Sang-Kwon KANG, Seoul (KR)

(21) Appl. No.: 18/720,071

(22) PCT Filed: Dec. 15, 2022
(86) PCT No.: PCT/KR2022/020441

§ 371 Date: Jun. 14, 2024

(30) Foreign Application Priority Data
Dec. 17, 2021 (KR) 10-2021-0181383

(51) Int. Cl. A63B 60/46; A63B 102/02; A63B 102/04; A63B 102/16; A63B 102/18; A63B 102/32

(52) U.S. Cl. CPC A63B 60/46; A63B 2102/02; A63B 2102/04; A63B 2102/16; A63B 2102/18; A63B 2102/32; A63B 2220/803; A63B 2220/806; A63B 2220/89; A63B 2230/62

(57) ABSTRACT

Disclosed is a method for providing sports training videos using a camera and a radar sensor. The present invention is configured so that, when a specific motion of a player is captured by means of radar sensors in a state where a player is being simultaneously captured in real time from various directions by means of one or more cameras during a game or training, only videos of an interval corresponding to the detected specific motion of the player are saved, thus making it possible to: analyze problems that the player has in the game or training through replays of the saved videos; correct problems that the player has during training on the basis of the results of the analysis by distinguishing between the player's incorrect posture and the posture suitable for the player's physical requirements, the player's posture during slumps and during good periods, etc.; correct the player's posture through comparison with the postures of good players and the maximization of the strengths of the player; prevent injuries caused by the player's incorrect posture; and improve skills through the minimization of the player's weaknesses.

### TECHNICAL FIELD

The present invention relates to a video provision technology for training of sports players (e.g. baseball, golf, tennis, badminton, table tennis, etc.), and more particularly, to a method for providing sports training videos using a camera and a radar sensor, which is configured so that, when a specific motion of a player is captured by means of radar sensors in a state where a player is being simultaneously captured in real time from various directions by means of one or more cameras during a game or training, only videos of an interval corresponding to the detected specific motion of the player are saved, thus making it possible to: analyze problems that the player has in the game or training through replays of the saved videos; and allowing s training correct problems that the player has during training on the basis of the results of the analysis.

### BACKGROUND ART

Generally, when broadcasting sports games such as baseball, golf, tennis, and badminton, 4 to 12 cameras are used, and cameramen directly capture the relevant video and transmit the necessary parts for broadcast.

In other words, video transmission cameras used in currently commercially available web cams and/or CCTVs operate two to eight cameras at the same time to transmit the video to a computer terminal, so that the video captured in all channels is transmitted through a monitor.

However, the above-mentioned transmission method is utilized for the purpose of interest and the progress of the game from the perspective of sports game broadcasting rather than from the perspective of player training.

In order for players to train, they must gather the videos of the player from various directions in one place, check all the videos on one screen, find the wrong parts, and train, however, capturing training videos for individual athletes has not been provided until now.

In other words, capturing one player with multiple cameras, editing and processing them so as to check only the necessary parts require a large number of people and time, and in particular, it is necessary to increase the hardware and/or server capacity of computer terminals in real time.

Therefore, conventionally, various tools have been used to help player training, but this is inconvenient because the player has to wear the tool himself, and the motion of the player is restricted due to wearing the tool, which causes a problem that the training is not carried out properly.

### DETAILED DESCRIPTION OF THE INVENTION

### Technical Problem

It is an object of the present invention to provide a method for providing sports training videos using a camera and a radar sensor, which is configured so that, when a specific motion of a player is captured by means of radar sensors in a state where a player is being simultaneously captured in real time from various directions by means of one or more cameras during a game or training, only videos of an interval corresponding to the detected specific motion of the player are saved, thus making it possible to: analyze problems that the player has in the game or training through replays of the saved videos; and allowing s training correct problems that the player has during training on the basis of the results of the analysis.

### Technical Solution

In order to achieve the above object, according to the present invention, there is provided a method for providing sports training videos using a camera and a radar sensor, the method comprising: a first step of capturing the game or training status of a player in real time using one or more cameras; a second step of detecting a specific motion of the player through a radar sensor when the motion occurs in the game or training state of the player captured in real time by the camera from the first step; a third step of storing, in a collection terminal, a section video corresponding to a specific motion of the player among real-time videos of the game or training state of the player by a camera from the first step, if a specific motion of the player is detected by the radar sensor from the second step; and a fourth step of transmitting the section video corresponding to a specific motion of the player stored in the collection terminal from the third step to a monitor and replaying the video, wherein the collection terminal is equipped with a training program that analyzes the saved section video corresponding to a specific motion of the player and provides correction information according to the analysis results, whereby when the section video corresponding to a specific motion of the player in the fourth step is replayed on the monitor, the training program further include a replay button and a save button that are clicked with a mouse on the screen of the monitor, at least one drawing tool for expressing the player's disordered posture in the replayed section video and a joint angle tool according to the motion of the player, and a tool for selecting a slow-motion double speed.

Also, the first step further comprises: a step of registering a player before the camera captures the game or training status of the player in real time, and a step of creating a player registration folder at the time of player registration from the step of registering the player.

Further, the first step further comprises a step of enlarging or reducing the video of the player's position through the zoom function setting of the camera, or selecting the brightness and color of the video according to the lighting condition, or selecting whether or not to capture at night.

Further, the first step further comprises a step of setting whether the camera's capturing time is to be advanced from the preparation posture of the player or is to be shortened by a necessary section only.

Further, in the first step, the camera is a CCTV camera using a USB-type webcam or POE LAN cable, which are placed based on the ceiling part for capturing for the game or training of the player from various directions as so to capture the specific motion of the player or the motion of a first sports tool and a second sports tool in real time.

Further, the first sports tool is one of a baseball bat, a golf club, a tennis racket, a badminton racket, and a ping-pong racket.

Further, the second sports tool is one of a baseball, a golf ball, a tennis ball, a shuttlecock, and a ping-pong ball.

Further, in the first step, the radar sensors are installed simultaneously or selectively on a front face, a back face and a side face of a registered player, so as to detect motion of the registered player from the action before the second sports tool flies to when the first sports tool hits the second sports tool or after the second sports tool has passed, and to detect the flying section of the second sports tool.

Further, the first step further comprises a step of adjusting the radar sensitivity of the radar sensor so that even minor motions of players can be captured.

Further, in the third step, the collection terminal is a computer terminal having a hard drive in communication with the camera or a web server having a database.

Further, the drawing tools provided on the screen of the monitor include a click button for drawing a straight line, a click button for drawing a diagonal line, a click button for freely drawing like a pen, and a click button for erasing.

Further, the tool for selecting the slow motion double speed is a click button capable of selecting a slow motion video at 2× to 12× speed.

Further, in the third step, a specific motion section video of the player stored in the collection terminal is a motion trajectory change amount of the player continuing until the next action of the player progresses, and saving of the section video to the collection terminal is determined by the save button.

Further, in the third step, a specific motion section video of a player stored in the collection terminal is divided into at least one or more channels, and stored simultaneously, or the section video captured from mutually different directions is each stored in at least one or more channels.

Further, in the third step, when the section video corresponding to a specific motion of a player is stored in the collection terminal, the section video is automatically saved in a player registration folder created from the first step.

Further, when section video is saved in the player registration folder, the capturing date and the capturing time are included in the saved section video information.

### Advantageous Effects

As set forth above, the present invention is configured so that, when a specific motion of a player is captured by means of radar sensors in a state where a player is being simultaneously captured in real time from various directions by means of one or more cameras during a game or training, only videos of an interval corresponding to the detected specific motion of the player are saved, whereby it can expect the effect of making it possible to: analyze problems that the player has in the game or training through replays of the saved videos; correct problems that the player has during training on the basis of the results of the analysis by distinguishing between the player's incorrect posture and the posture suitable for the player's physical requirements, the player's posture during slumps and during good periods, etc.; correct the player's posture through comparison with the postures of good players and the maximization of the strengths of the player; prevent injuries caused by the player's incorrect posture; and improve skills through the minimization of the player's weaknesses.

Effects of the present invention are not limited to the effects mentioned above, and additional other effects not mentioned herein will be clearly understood from the detailed description and the appended claims by those skilled in the art.

### BRIEF DESCRIPTION OF THE DRAWINGS

FIG. 1 is 1 is a schematic diagram of a system for providing sports training videos using a camera and a radar sensor according to an embodiment of the present invention.

FIG. 2 is a flowchart showing a method for providing sports training videos using a camera and a radar sensor according to an embodiment of the present invention.

FIGS. 3 and 4 are screen diagrams showing a state in which the game or training status of a player captured in real time by a camera is displayed on a monitor which is connected to a collection terminal according to an embodiment of the present invention.

### DETAILED DESCRIPTION OF THE EMBODIMENTS

Hereinafter, various embodiments of the present invention will be described with reference to the accompanying drawings.

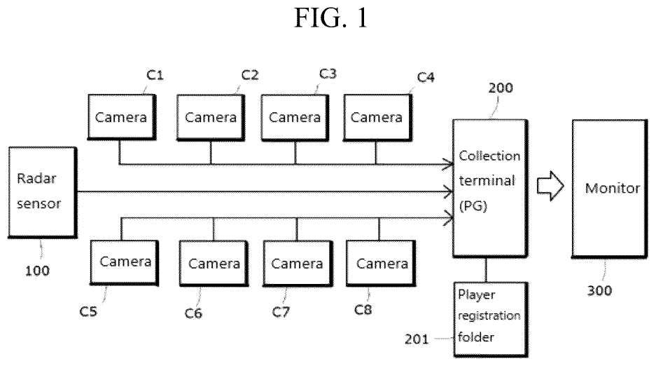

FIG. 1 is 1 is a schematic diagram of a system for providing sports training videos using a camera and a radar sensor according to an embodiment of the present invention.

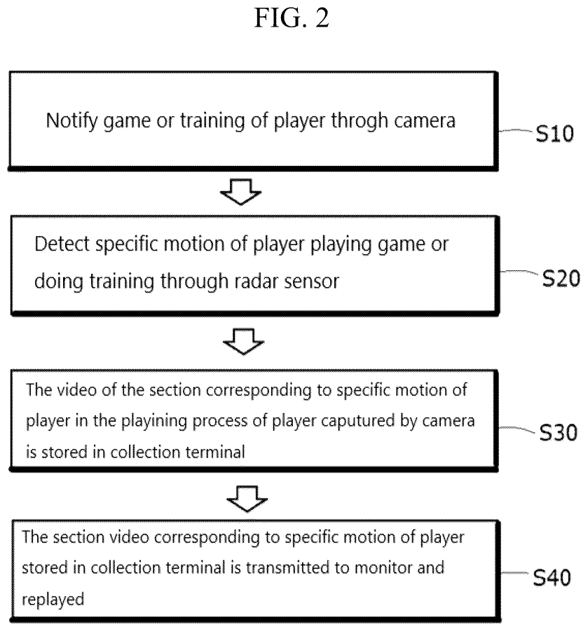

FIG. 2 is a flowchart showing a method for providing sports training videos using a camera and a radar sensor according to an embodiment of the present invention.

Referring to FIG. 2, the method for providing sports training videos using a camera and a radar sensor according to an embodiment of the present invention can be achieved by constructing the system shown in FIG. 1.

That is, as shown in FIG. 1, at least one or more cameras (C1,˜,C8), a radar sensor 100, a collection terminal 200, and a monitor 300 are connected using a cable or a communication network.

At this time, the cameras (C1,˜,C8) may be a CCTV camera using a USB-type webcam or POE LAN cable, which are placed based on the ceiling part for capturing for the game or training of the player from various directions as so to capture the specific motion of the player or the motion of a first second sports tool (e.g. baseball bat, golf club, tennis racket, badminton racket, ping-pong racket) and a second sports tool e.g. baseball, golf ball, tennis ball, shuttlecock, ping-pong ball) in real time.

In addition, the radar sensor 100 may be installed simultaneously or selectively on a front face, a back face and a side face of a registered player, so as to detect motion of the registered player from the action before the second sports tool flies to when the first sports tool hits the second sports tool or after the second sports tool has passed, and to detect the flying section of the second sports tool.

Here, the collection terminal 200 may be a computer terminal having a hard drive in communication with the camera (C1,˜,C8) or a web server having a database. If the collection terminal 200 is a web server, a computer terminal or a mobile terminal can be connected to the web server through a communication network, whereby the monitor 300 may be a monitor connected to the computer terminal or a screen of a portable terminal.

Therefore, the method for providing sports training videos using a camera and a radar sensor according to an embodiment of the present invention, which is implemented by a system constructed as described above, may include first to fourth steps (S10, S20, S30, S4).

The first step (S10) is to capture the game or training status of the player in real time using at least one or more constructed camera (C1,˜,C8).

That is, in the first step (S10), the sports game or training status of the player is captured in real time through the cameras C1,˜,C8, and the captured videos are not stored in the collection terminal 200, but may be only displayed on the monitor 300.

On the other hand, when the sports game or training status of the player are captured in real time through the cameras (C1,˜,C8), a priority setting process is required. Therefore, in the first step (S10), before the sports game or training status of the player are captured in real time through the cameras (C1,˜,C8), not only player registration is performed in the collection terminal 200, but also when a player is registered, a player registration folder 201 is created in the collection terminal 200.

Here, the cameras (C1,˜,C8) not only enlarges or reduces the video of the player's position through the zoom function setting of the camera, or selects the brightness and color of the video according to the lighting condition, or selects whether or not to capture at night, but also sets whether the camera's capturing time is to be advanced from the preparation posture of the player or is to be shortened by a necessary section only.

In addition, in the first step (S10), a setting process is carried out to adjust the radar sensitivity of the radar sensor 100 so that even minor motion of the player can be captured through the cameras C1,˜,C8. In particular, in the case of measuring professional players, the radar sensitivity is set to match the fast motion of the player, thereby allowing the cameras (C1,˜,C8) to precisely capture only the necessary portions.

The second step (S20) is to detect a specific motion of the player through the radar sensor 100 when the motion occurs in the game or training state of the player captured in real time by the cameras (C1, ˜,C8).

That is, the radar sensor 100 detects the motion of the player, for example, from the player's actions before the second sport tool (e.g. baseball, golf ball, tennis ball, shuttlecock, ping-pong ball) thrown by the player or hit by the first sports tool (e.g. baseball bat, golf club, tennis racket, badminton racket, ping-pong racket) to the motion of the registered player after the first sports tool (e.g. baseball bat, golf club, tennis racket, badminton racket, ping-pong racket) held by the player hits the second sport tool or after the second sport tool has passed, and the flying section of the second sport tool,

In the next third step (S30), the collection terminal 200 stores the section video corresponding to a specific motion of the player among the real-time videos in the game or training state of the player through the cameras C1,˜,C8, if a specific motion of the player is detected by the radar sensor 100.

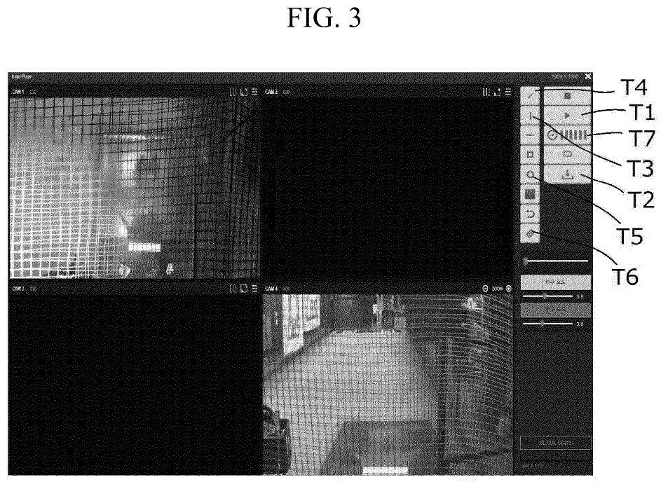

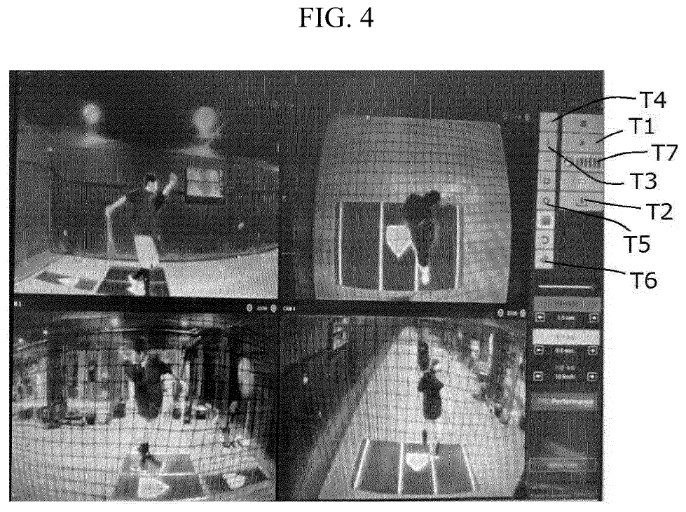

At this time, the collection terminal 200 is equipped with a training program (PG) that analyzes the saved section video corresponding to the player's specific motion and provides correction information according to the result of the analysis. In addition, as shown in FIGS. 3 and 4, when displaying a video on the monitor 300, the screen displays a replay click button (T1), a save button (T2), a straight line drawing click button (T3) which is at least one drawing tool for expressing the player's disordered posture in the replayed section video, a diagonal line drawing click button (T4), a click button (T5) for free drawing like a pen, an erase click button (T6), and a click button (T7) which can select slow motion video at 2× to 12× speed as a tool for selecting a slow motion double speed.

Therefore, a specific motion section video of the player stored in the collection terminal 200 is a motion trajectory change amount of the player continuing until the next action of the player progresses, and saving of the section video to the collection terminal 200 is determined by clicking the save button (T2) using a mouse, etc., In this case, a specific motion section video of a player stored in the collection terminal 200 is divided into at least one or more channels, and stored simultaneously, or the section video captured from mutually different directions may be each stored in at least one or more channels.

Here, the player registration folder 201 is created in the collection terminal 200 when a player is registered, and therefore, when a section video corresponding to a specific motion of a player in the collection terminal 200 is stored in the player registration folder 201, the section video can be automatically stored in the player registration folder 201, which is to make it easier to distinguish and search for the status of specific motion for the player's training service. In this case, the section video information stored in the player registration folder 201 includes the capturing date and the capturing time.

The next fourth step (S40) is to transmit the section video corresponding to the specific motion of the player stored in the collection terminal 200 to the monitor 300 so that it can be replayed. That is, when the collection terminal 200 replays the stored section video corresponding to the player's specific motion on the monitor 300, the training program (PG) mounted on the collection terminal 200 provides, on the screen of the monitor 300, a replay button (T1), a save button (T2), at least one or more drawing tools for expressing the player's disordered posture in the replayed section video and a joint angle tool according to the motion of the player (T3, T4, T5, T6), and a tool for selecting slow motion speed (T7). On the monitor 300, when the saved section video is replayed, not only it is possible to check whether the player's posture is normal or abnormal, such as disordered, through drawing and editing using the above tools, but also training for correcting the posture can proceed through that confirmation.

In one example, assuming that the sports game is baseball, and when a player is playing as a batter or practicing batting, a specific motion according to the game or training is detected and the detected section video is a 15-second swing process, the collection terminal 200 can provide a section video measured from the time the batter goes into the preparation posture to face the pitcher to the follow-up posture of the swing after hitting.

At this time, the training program (PG) mounted on the collection terminal 200 is given a timer function, and the section video allows measurement of the moment of hitting or a specific location rather than the entire hitting video. In this case, it is possible to automatically detect the point at which the ball flies when the batter bats, and set the capturing section of the hitting video.

In addition, the motion of the swing can be detected from the time the batter prepares to swing until the swing is completed, and only the video of the detected section can be captured and saved. In this case, the point at which the swing quickly rotates is the time that occurs after 0.75 seconds from the batting posture, and the radar sensor 100 detects a swing section of a total of 1.5 seconds while capturing from 0.75 seconds before the bat returns to 0.75 seconds after the swing is completed, and this detection section can also be saved.

On the other hand, assuming that the sports game is baseball and when a player is playing as a batter or practicing batting, a specific motion according to the game or training is detected and the detected section video is the pitching process, it detects the time from when the pitcher winds up while holding the ball or takes a set position, to the moment when the pitcher throws the ball and steps on it, and stores this as a section video. This means that the radar sensor 100 detects the process of the ball flying away from the hand, and can store and provide a section video from 0.75 seconds before the ball is thrown to 0.75 when the ball flies.

On the other hand, assuming that the sports game is golf and when a player is s playing a game or doing swing training, a specific motion according to the game or training is detected and the detected section video is a swing process, the radar sensor 100 detects the golfer hitting the ball, records the section from 1 second before hitting to 1 second after hitting, and provides video of the golfer's aim, take away, hitting, release, and follow-up.

In addition, as a function for capturing a golfer's empty swing, it is possible to capture the motion at the start of the takeaway and provide a section video measuring the section from 0.5 seconds before to 1.5 seconds after.

Therefore, in embodiments of the present invention, the game or training status of the player is captured in real time through cameras (C1,˜,C8), but the captured video is not saved. Only when the specific motion of the player is detected by the radar sensor 100, the section video is saved and provided to the player. Therefore, it is possible to achieve the training results which correct problems that the player has during training on the basis of the results of the analysis by distinguishing between the player's incorrect posture and the posture suitable for the player's physical requirements, the player's posture during slumps and during good periods, etc.; correct the player's posture through comparison with the postures of good players and the maximization of the strengths of the player; prevent injuries caused by the player's incorrect posture; and improve skills through the minimization of the player's weaknesses.

### INDUSTRIAL APPLICABILITY

The technical idea of the method for providing sports training videos using a camera and a radar sensor of the present invention has been illustrated and described above with reference to the accompanying drawings, but this is merely an illustrative description of the most preferred embodiment of the present invention and is not intended to limit the present invention.

Therefore, the present invention is not limited to preferred embodiments described above, and numerous other modifications can be made by those skilled in the art, without departing from the spirit and scope of the invention described in the appended claims.

1. A method for providing sports training videos using a camera and a radar sensor, the method comprising:
a first step of capturing the game or training status of a player in real time using one or more cameras;
a second step of detecting a specific motion of the player through a radar sensor when the motion occurs in the game or training state of the player captured in real time by the camera from the first step;
a third step of storing, in a collection terminal, a section video corresponding to a specific motion of the player among real-time videos of the game or training state of the player by a camera from the first step, if a specific motion of the player is detected by the radar sensor from the second step; and
a fourth step of transmitting the section video corresponding to a specific motion of the player stored in the collection terminal from the third step to a monitor and replaying the video,
wherein the collection terminal is equipped with a training program that analyzes the saved section video corresponding to a specific motion of the player and provides correction information according to the analysis results, whereby when the section video corresponding to a specific motion of the player in the fourth step is replayed on the monitor, the training program further include a replay button and a save button that are clicked with a mouse on the screen of the monitor, at least one drawing tool for expressing the player's disordered posture in the replayed section video and a joint angle tool according to the motion of the player, and a tool for selecting a slow-motion double speed.

2. The method for providing sports training videos using a camera and a radar sensor according to claim 1, wherein the first step further comprises:
a step of registering a player before the camera captures the game or training status of the player in real time, and
a step of creating a player registration folder at the time of player registration from the step of registering the player.

3. The method for providing sports training videos using a camera and a radar sensor according to claim 1, wherein the first step further comprises:
a step of enlarging or reducing the video of the player's position through the zoom function setting of the camera, or selecting the brightness and color of the video according to the lighting condition, or selecting whether or not to capture at night.

4. The method for providing sports training videos using a camera and a radar sensor according to claim 3, wherein the first step further comprises:
a step of setting whether the camera's capturing time is to be advanced from the preparation posture of the player or is to be shortened by a necessary section only.

5. The method for providing sports training videos using a camera and a radar sensor according to claim 4, wherein:
in the first step, the camera is a CCTV camera using a USB-type webcam or POE LAN cable, which are placed based on the ceiling part for capturing for the game or training of the player from various directions as so to capture the specific motion of the player or the motion of a first sports tool and a second sports tool in real time.

6. The method for providing sports training videos using a camera and a radar sensor according to claim 5, wherein:
the first sports tool is one of a baseball bat, a golf club, a tennis racket, a badminton racket, and a ping-pong racket.

7. The method for providing sports training videos using a camera and a radar sensor according to claim 6, wherein
the second sports tool is one of a baseball, a golf ball, a tennis ball, a shuttlecock, and a ping-pong ball.

8. The method for providing sports training videos using a camera and a radar sensor according to claim 7, wherein:
in the first step, the radar sensors are installed simultaneously or selectively on a front face, a back face and a side face of a registered player, so as to detect motion of the registered player from the action before the second sports tool flies to when the first sports tool hits the second sports tool or after the second sports tool has passed, and to detect the flying section of the second sports tool.

9. The method for providing sports training videos using a camera and a radar sensor according to claim 8, wherein:
the first step further comprises a step of adjusting the radar sensitivity of the radar sensor so that even minor motions of players can be captured.

10. The method for providing sports training videos using a camera and a radar sensor according to claim 1, wherein:
in the third step, the collection terminal is a computer terminal having a hard drive in communication with the camera or a web server having a database.

11. The method for providing sports training videos using a camera and a radar sensor according to claim 1, wherein:
the drawing tools provided on the screen of the monitor include a click button for drawing a straight line, a click button for drawing a diagonal line, a click button for freely drawing like a pen, and a click button for erasing.

12. The method for providing sports training videos using a camera and a radar sensor according to claim 11, wherein:
the tool for selecting the slow motion double speed is a click button capable of selecting a slow motion video at 2× to 12× speed.

13. The method for providing sports training videos using a camera and a radar sensor according to claim 12, wherein:
in the third step, a specific motion section video of the player stored in the collection terminal is a motion trajectory change amount of the player continuing until the next action of the player progresses, and saving of the section video to the collection terminal is determined by the save button.

14. The method for providing sports training videos using a camera and a radar sensor according to claim 12, wherein:
in the third step, a specific motion section video of a player stored in the collection terminal is divided into at least one or more channels, and stored simultaneously, or the section video captured from mutually different directions is each stored in at least one or more channels.

15. The method for providing sports training videos using a camera and a radar sensor according to claim 14, wherein:
in the third step, when the section video corresponding to a specific motion of a player is stored in the collection terminal, the section video is automatically saved in a player registration folder created from the first step.

16. The method for providing sports training videos using a camera and a radar sensor according to claim 15, wherein:
when section video is saved in the player registration folder, the capturing date and the capturing time are included in the saved section video information.
